(19) United States
(12) Patent Application Publication
(10) Pub. No.: US 2022/0331802 A1
(43) Pub. Date: Oct. 20, 2022

(54) BURSTABLE LIQUID STORAGE PACKAGE FOR BIOLOGICAL MATERIALS AND VALVE SUBSTITUTION

(71) Applicant: THE REGENTS OF THE UNIVERSITY OF CALIFORNIA, Oakland, CA (US)

(72) Inventors: Alfonso Shin, Irvine, CA (US); Roya Shiri, Irvine, CA (US); Yujia Liu, Irvine, CA (US); Snehan Peshin, Irvine, CA (US); Derosh George, Irvine, CA (US); Marc Madou, Irvine, CA (US)

(21) Appl. No.: 17/721,826

(22) Filed: Apr. 15, 2022

Related U.S. Application Data
(60) Provisional application No. 63/176,063, filed on Apr. 16, 2021.

(51) Int. Cl. B01L 3/00; F16K 99/00; B01L 9/00; B01L 7/00

(52) U.S. Cl. CPC B01L 3/502769; F16K 99/004; B01L 3/502707; B01L 3/5021; B01L 9/00; B01L 7/00; B01L 2200/0689; B01L 2200/12; B01L 2400/0677; F16K 2099/0084

(57) ABSTRACT

The present invention is directed to an apparatus and method of fabricating a sealed storage system for environmentally sensitive aqueous materials with liquid flow control and on-demand distribution. The present invention features a sealed storage apparatus capable of compactly containing a liquid reagent with liquid control capabilities. The apparatus may comprise a liquid-impermeable, air-impermeable, resistant to force-induced tearing pouch body capable of being penetrated through the application of a laser. The apparatus may further comprise a pouch cavity disposed within the pouch body for holding the liquid reagent. The apparatus may further comprise a liquid-impermeable, air-impermeable, and resistant to force-induced tearing sealing adhesive disposed over the pouch cavity to seal the liquid reagent within the pouch body capable of being penetrated through the application of the laser. Thus, the apparatus may allow liquid to flow from any point on the said apparatus by simply directing the laser to the point.

### CROSS-REFERENCES TO RELATED APPLICATIONS

This application is a non-provisional and claims benefit of U.S. Provisional Application No. 63/176,063 filed Apr. 16, 2021, the specification of which is incorporated herein in its entirety by reference.

### FIELD OF THE INVENTION

The present invention is directed to an apparatus and method of fabricating a sealed storage system for environmentally sensitive aqueous materials with liquid flow control and on-demand distribution.

### BACKGROUND OF THE INVENTION

While countless methods for storage of aqueous materials exist, many are met with obstacles during incorporation into point-of-care devices for medical screening and ease of use. Complications have arisen during the multitude of steps from conception to integration of liquid storage methods into point-of-care diagnostics including but not limited to dimensional and size constraints, material costs, reproducibility, and compatibility with automation.

A significant impediment of common methods for liquid storage on point-of-care platforms such as centrifugal diagnostic devices is the finite amount of space available for storage due to necessary features for optimized assay performance. To minimize the amount of occupied space, many have turned to the strategy of lyophilizing critical reagents for assay performance. However, this technique requires the addition of solvent prior to use and detracts from the appeal of automated testing associated with many diagnostic platforms. Additionally, this technique is not widely applicable to all liquid reagents and is not optimal for some essential components of existing biological assays such as secondary antibodies required in ELISAs. Thus, there exists a present need for an apparatus for liquid storage that minimizes the amount of occupied space that is applicable to a wide range of liquid reagents.

### BRIEF SUMMARY OF THE INVENTION

It is an objective of the present invention to provide apparatuses and fabrication methods that allow for compact and widely applicable storage of liquid reagents with liquid flow control capabilities, as specified in the independent claims. Embodiments of the invention are given in the dependent claims. Embodiments of the present invention can be freely combined with each other if they are not mutually exclusive.

The present invention features a sealed storage apparatus capable of compactly containing a liquid reagent with liquid control capabilities. In some embodiments, the apparatus may comprise a pouch body made of a material that is liquid-impermeable, air-impermeable, and resistant to force-induced tearing. The pouch body may be penetrated through the application of a laser. The apparatus may further comprise a pouch cavity disposed within the pouch body for holding the liquid reagent. The apparatus may further comprise a sealing adhesive disposed over the pouch cavity to seal the liquid reagent within the pouch body. A material of the sealing adhesive may be liquid-impermeable, air-impermeable, and resistant to force-induced tearing, as well as create a seal that may be liquid-impermeable, air-impermeable, and resistant to force-induced tearing and may be penetrated through the application of the laser. Thus, the apparatus may allow liquid to flow from any point on the said apparatus by simply directing the laser to the point.

The present invention features a method of fabricating a sealed storage apparatus capable of compactly containing a liquid reagent with liquid control capabilities. In some embodiments, the method may comprise placing a first material over a mold. The first material may be liquid-impermeable, air-impermeable, resistant to force-induced tearing, and may be penetrated through the application of a laser. The method may further comprise heating the first material and using a stamp to press the first material into the mold cavity to create a pouch body and a pouch cavity disposed within the opening of the pouch body. The shape of the pouch body may be the same as the shape of the mold cavity and the shape of the pouch cavity may be the same as the shape of the stamp. The method may further comprise filling the cavity with the liquid reagent and placing a sealing adhesive over the opening of the pouch body, such that the sealing adhesive seals the liquid reagent within the pouch body. A material of the sealing adhesive may be liquid-impermeable, air-impermeable, and resistant to force-induced tearing and may be penetrated through the application of the laser. In some embodiments, the method may further comprise steps for controlling the liquid reagent contained within the sealed storage apparatus comprising directing the laser to a point on the pouch body to cause melting at the point on the pouch body such that the liquid reagent flows out of the pouch cavity.

One of the unique and inventive technical features of the present invention is the use of a material that is liquid-impermeable, air-impermeable, and resistant to force-tearing but capable of being penetrated by a laser for containing liquid reagents to create a sealed storage apparatus that also acts as a phase-change microvalve. Without wishing to limit the invention to any theory or mechanism, it is believed that the technical feature of the present invention advantageously provides for dimensional variability, cost, and reproducibility of a multi-use sealed storage apparatus that promotes safe and indefinite storage of a wide range of liquid reagents as well as efficient liquid control and mixing within a microfluidic platform. None of the presently known prior references or work has the unique inventive technical feature of the present invention.

Furthermore, the inventive technical feature of the present invention is counterintuitive. The reason that it is counterintuitive is because the prior references teach away from the inventive technical feature. Prior systems for reagent storage and valving would rely on lyophilization of material with resuspension during reaction and fluidic control components, respectively as storing a reagent in liquid form is commonly prone to leakage. On the contrary, the present invention does NOT implement any fluidic control components and keeps the reagent in liquid form. The sealed storage apparatus of the present invention is punctured in order to act as both a valve and a storage unit. Thus, the prior references teach away from the inventive technical feature of the present invention and is counterintuitive.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a diagram of a sealed storage apparatus of the present invention.

FIGS. 2A-2E show a plurality of diagrams of a method of the present invention for fabricating the sealed storage apparatus and actuating a liquid control mechanism of the said sealed storage apparatus.

FIG. 3 shows an alternate flow chart of diagrams showing the method of fabrication of the sealed storage apparatus of the present invention.

FIGS. 4A-4B show a plurality of photographs showing how the sealed storage apparatus may be mounted onto a microfluidic disc.

FIG. 5 shows the microfluidic CD platform of the present invention comprising a plurality of sealed storage apparatuses.

### DETAILED DESCRIPTION OF THE INVENTION

Following is a list of elements corresponding to a particular element referred to herein:
100 sealed storage apparatus
110 pouch body
120 pouch cavity
130 sealing adhesive
210 mold
220 stamp
230 laser
300 microfluidic platform

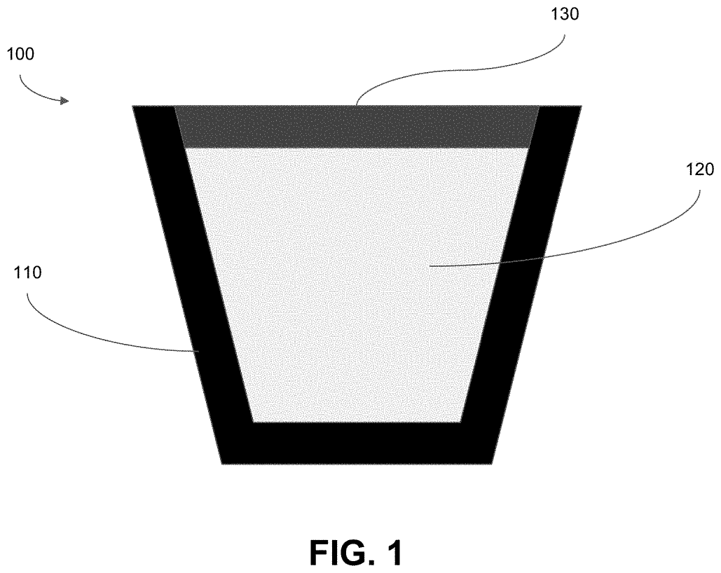

Referring now to FIG. 1, the present invention features a sealed storage apparatus (100) capable of compactly containing a liquid reagent with liquid control capabilities. In some embodiments, the apparatus (100) may comprise a pouch body (110) having an opening. The opening allows the apparatus (100) to be filled with the liquid reagent. A material of the pouch body (110) may be liquid-impermeable, air-impermeable, and resistant to force-induced tearing. In some embodiments, the material of the pouch body (110) may comprise thermoformed black mylar material. Furthermore, the material of the pouch body (110) may be compatible with a wider range of liquid reagents than prior systems of lyophilizing critical reagents. The pouch body (110) may be penetrated through the application of a specialized device. In some embodiments, the specialized device may be a laser (230). The laser (230) may comprise an infrared laser. The apparatus (100) may further comprise a pouch cavity (120) disposed within the opening of the pouch body (110). The liquid reagent may be disposed within the pouch cavity (120). The apparatus (100) may further comprise a sealing adhesive (130) disposed over the pouch cavity (120). The sealing adhesive (130) may seal the liquid reagent within the pouch body (110). A material of the sealing adhesive (130) may be liquid-impermeable, air-impermeable, and resistant to force-induced tearing, as well as create a seal that may be liquid-impermeable, air-impermeable, and resistant to force-induced tearing. In some embodiments, the material of the sealing adhesive (130) may comprise aluminum-coated black mylar adhesive. The sealing adhesive (130) may be penetrated through the application of the laser (230). Thus, the apparatus (100) may allow liquid to flow from any point on the said apparatus (100) by simply directing the laser (230) to the point.

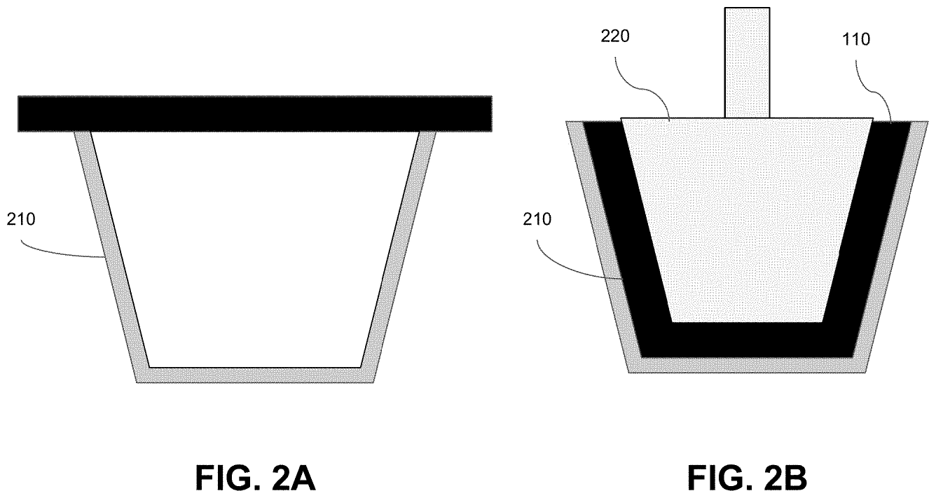

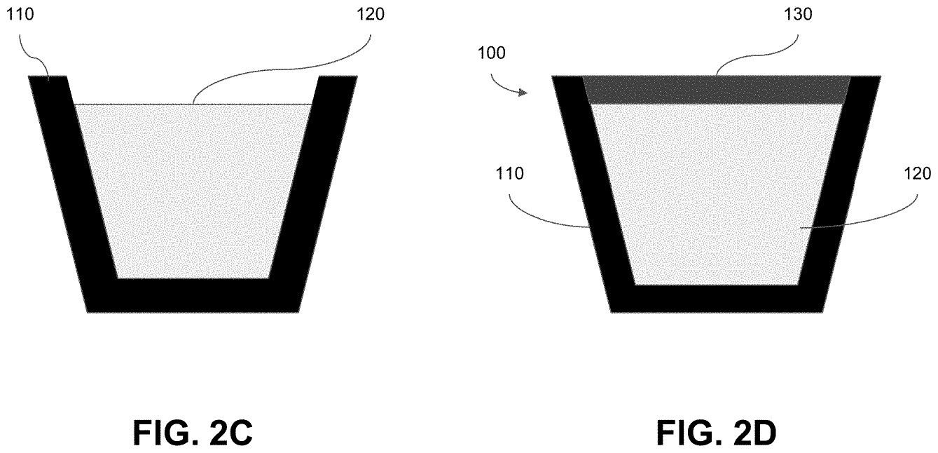

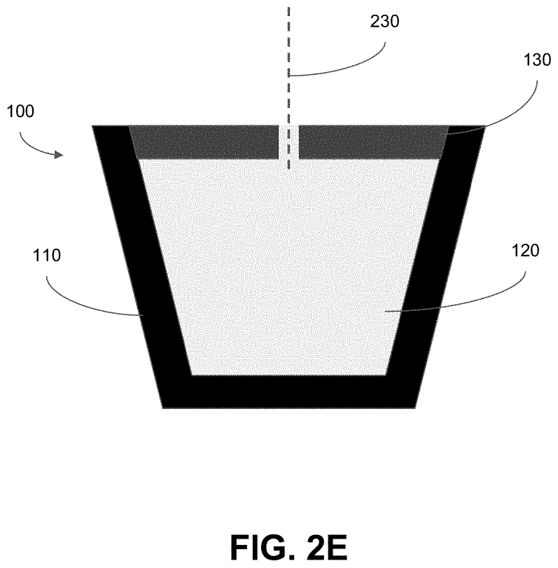

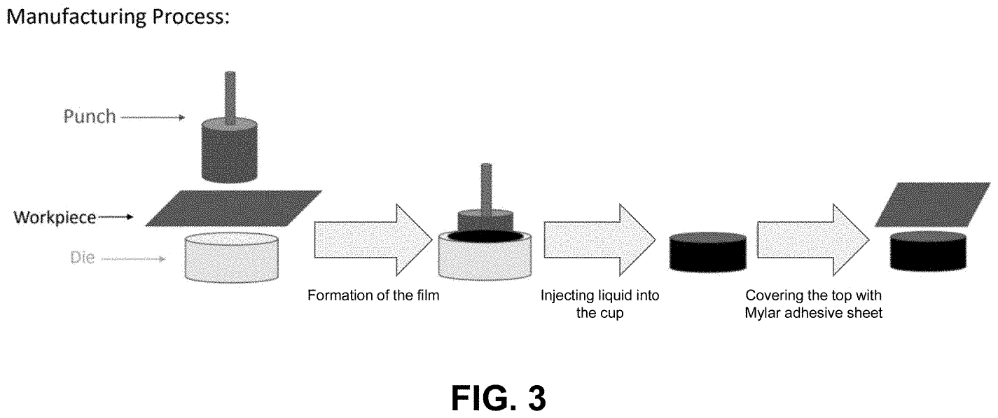

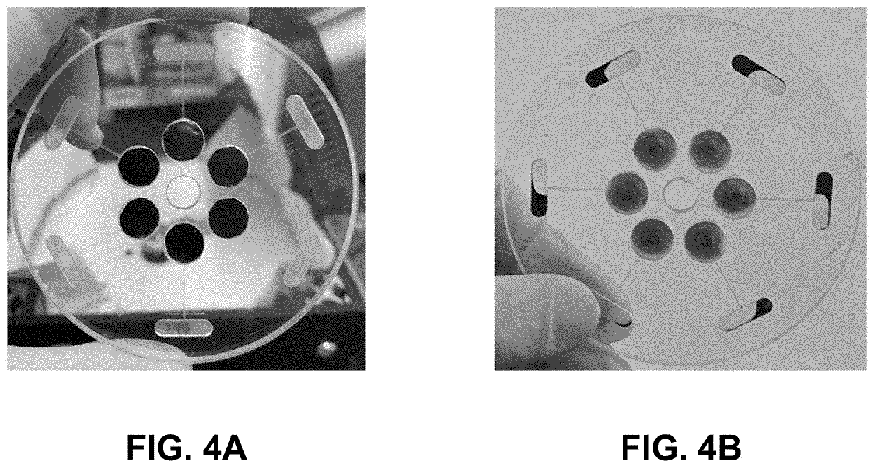

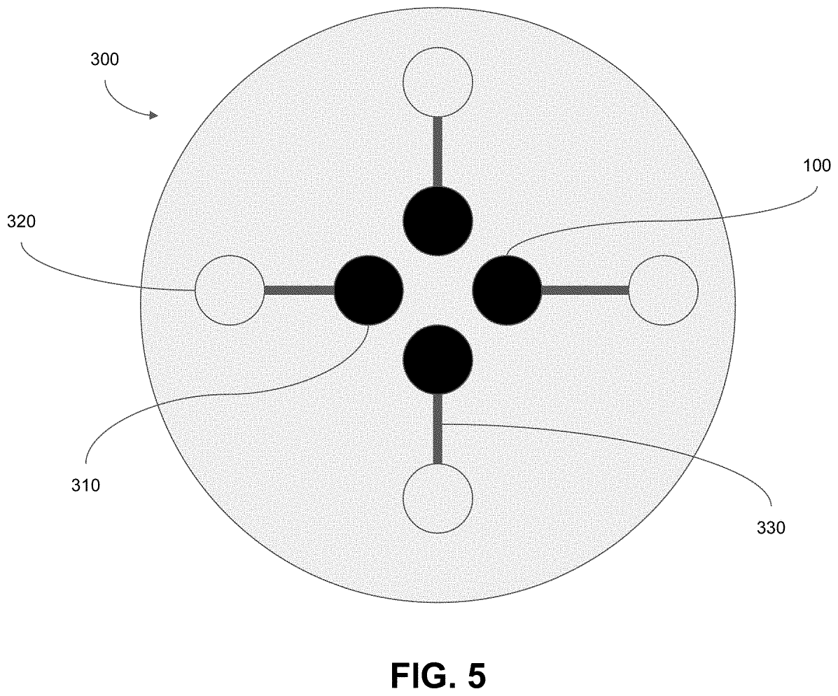

Referring now to FIGS. 2A-2E, the present invention features a method of fabricating a sealed storage apparatus (100) capable of compactly containing a liquid reagent with liquid control capabilities. In some embodiments, the method may comprise placing a first material over a mold (210) having a mold cavity. The first material may be liquid-impermeable, air-impermeable, and resistant to force-induced tearing. Furthermore, the first material may be compatible with a wider range of liquid reagents than prior systems of lyophilizing critical reagents. The first material may be penetrated through the application of a specialized device. In some embodiments, the first material may comprise black mylar material. In some embodiments, the specialized device may be a laser (230). The laser (230) may comprise an infrared laser. The method may further comprise heating the first material. The method may further comprise using a stamp (220) to press the first material into the mold cavity to create a pouch body (110) having an opening, and a pouch cavity (120) disposed within the opening of the pouch body (110). In some embodiments, the stamp (220) may comprise a thermally conductive metal stamp. The opening allows the apparatus (100) to be filled with the liquid reagent. The shape of the pouch body (110) may be the same as the shape of the mold cavity and the shape of the pouch cavity (120) may be the same as the shape of the stamp (220). The method may further comprise filling the cavity with the liquid reagent. The method may further comprise placing a sealing adhesive (130) over the opening of the pouch body (110), such that the sealing adhesive (130) seals the liquid reagent within the pouch body (110). A material of the sealing adhesive (130) may be liquid-impermeable, air-impermeable, and resistant to force-induced tearing. The sealing adhesive (130) may be penetrated through the application of the laser (230). In some embodiments, the material of the sealing adhesive (130) may comprise aluminum-coated black mylar adhesive. In some embodiments, the method may further comprise steps for controlling the liquid reagent contained within the sealed storage apparatus (100) comprising directing the laser (230) to a point on the pouch body (110). The laser (230) may cause melting at the point on the pouch body (110) such that the liquid reagent flows out of the pouch cavity (120) through the point on the pouch body (110) without mixing with the melted material of the pouch body (110). Tear-resistance of the container has been tested with assembly and mounting onto a centrifugal disc and rotated at 10,000 RPM for one minute. Following rotation, valving capabilities of the material were tested using an infrared laser to penetrate the mylar material and allow access to the loaded dyed water. The sealed storage apparatus of the present invention may be mounted onto a microfluidic disc, as seen in FIGS. 4A-4B.

In some embodiments, the microfluidic platform (300) may be a centrifugal disc (CD) platform comprising one or more reagent chambers (310) and one or more collection chambers (320) fluidly connected to the one or more reagent chambers (310) by one or more microfluidic channels (330). One or more sealed storage apparatuses may be disposed in the one or more reagent chambers (310). Actuating the CD platform after penetrating the one or more sealed storage apparatuses may cause the liquid reagent to travel from the one or more reagent chambers (310), through the one or more microfluidic channels (330), into the one or more collection chambers (320).

The present invention features a microfluidic centrifugal disk (CD) platform (300) comprising one or more reagent chambers (310), one or more collection chambers (320) fluidly connected to the one or more reagent chambers (310) by one or more microfluidic channels (330), and one or more sealed storage apparatuses (100) disposed within the one or more reagent chambers (310). Each apparatus (100) may comprise a material that is liquid-impermeable, air-impermeable, and resistant to force-induced tearing. The material penetrated through application of a specialized device, wherein a liquid reagent is disposed within the pouch cavity (120). The present invention additionally features a method for delivering a reagent throughout the microfluidic CD platform (300). The method may comprise penetrating the one or more sealed storage apparatuses (100) through use of a specialized device and actuating the microfluidic CD platform (300) such that fluid from the one or more sealed storage apparatuses (100) is directed from the one or more reagent chambers (310) to the one or more collection chambers (320). In some embodiments, the specialized device may comprise a laser (130). The laser (230) may comprise an infrared laser.

The present invention features a sealed storage apparatus (100) capable of compactly containing a liquid reagent while acting as a phase-change microvalve, the apparatus (100). The apparatus (100) may comprise a material that is liquid-impermeable, air-impermeable, and resistant to force-induced tearing. The apparatus (100) may be penetrated through the application of a specialized device. The apparatus (100) may be integrated into a microfluidic platform (300) such that penetrating the apparatus (100) causes the liquid reagent to dispense into the microfluidic platform (300). In some embodiments, the microfluidic platform (300) may be a centrifugal disc platform. Penetrating the sealed storage apparatus (100) may promote mixing a fluid directed through the microfluidic platform (300) with the liquid reagent stored within the sealed storage apparatus (100). The specialized device may comprise a laser (230).

The present invention is currently applied in centrifugal microfluidics diagnostic systems as a sealed tear-resistant storage system for aqueous reagents with on-demand distribution of stored liquids utilizing laser-puncture of packaging material. The current invention simultaneously addresses two common but critical features for centrifugal microfluidics in a long-term storage method built into the device as well as a controlled valving mechanism for liquid flow control. Using thermoforming techniques with mylar-based materials, these liquid-impermeable, air-impermeable, and tear-resistant pouches can be manufactured with appropriate reagents sealed inside. Pouches are manufactured using heated metal stamps to press the mylar material into a heated mold cavity, stretching the material into the intended shape and size. Material is then left to cool to form the cavity with volume definition and filled with a liquid reagent. Pouches are sealed using mylar adhesive coated with aluminum to minimize liquid exposure to oxidation and pressed to ensure sealing.

Following assembly onto microfluidic platforms, pouches can be utilized for liquid storage on CD and punctured using guided infrared laser exposure to dispense reagents to facilitate essential steps for diagnostic assays on the centrifugal microfluidic system. Due to the tear-resistant nature of the pouches, the high levels of force necessary to perform steps during previous stages of the assay will not compromise the structural integrity of the pouches, enabling reliable, on-device storage. Pouches have exhibited stability without leakage at rotational speeds of up to 10,000 rotations per minute (rpm) as well as reliable distribution of liquid following puncturing. This invention is also highly compatible with automated platforms due to the laser-controlled valving, a common feature in many existing systems. FIGS. 4A-4B show the integration of the sealed storage apparatus of the present invention into a microfluidic platform.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A sealed storage apparatus (100) capable of compactly containing a liquid reagent while acting as a phase-change microvalve, the apparatus (100) comprising:
a. a pouch body (110) having an opening;
wherein a material of the pouch body (110) is liquid-impermeable, air-impermeable, and resistant to force-induced tearing;
wherein the pouch body (110) is penetrated through application of a specialized device;
b. a pouch cavity (120) disposed within the opening of the pouch body (110);
wherein the liquid reagent is disposed within the pouch cavity (120);
c. a sealing adhesive (130) disposed over the pouch cavity (120);
wherein the sealing adhesive (130) seals the liquid reagent within the pouch body (110);
wherein a material of the sealing adhesive (130) is liquid-impermeable, air-impermeable, and resistant to force-induced tearing;
wherein the sealing adhesive (130) is penetrated through application of the specialized device; and
wherein the sealed storage apparatus (100) is integrated into a microfluidic platform (300) such that penetrating the sealed storage apparatus (100) causes the liquid reagent to dispense into the microfluidic platform (300).

2. The apparatus (100) of claim 1, wherein the material of the pouch body (110) comprises thermoformed black mylar material.

3. The apparatus (100) of claim 1, wherein the material of the sealing adhesive (130) comprises aluminum-coated black mylar adhesive.

4. The apparatus (100) of claim 1, wherein the microfluidic platform (300) is a centrifugal disc (CD) platform comprising one or more reagent chambers (310) and one or more collection chambers (320) fluidly connected to the one or more reagent chambers (310) by one or more microfluidic channels (330), wherein one or more sealed storage apparatuses are disposed in the one or more reagent chambers (310), wherein actuating the CD platform after penetrating the one or more sealed storage apparatuses causes the liquid reagent to travel from the one or more reagent chambers (310), through the one or more microfluidic channels (330), into the one or more collection chambers (320).

5. The apparatus (100) of claim 1, wherein penetrating the sealed storage apparatus (100) promotes mixing a fluid directed through the microfluidic platform (300) with the liquid reagent stored within the sealed storage apparatus (100).

6. The apparatus (100) of claim 1, wherein the specialized device comprises a laser (230).

7. The apparatus (100) of claim 6, wherein the laser (230) comprises an infrared laser.

8. A method of fabricating a sealed storage apparatus (100) capable of compactly containing a liquid reagent while acting as a phase-change microvalve, the method comprising:
a. placing a first material over a mold (210) having a mold cavity;
wherein the first material is liquid-impermeable, air-impermeable, and resistant to force-induced tearing;
wherein the first material is penetrated through application of a specialized device;
b. heating the first material;
c. pressing, by a stamp (220), the first material such that the first material is pressed into the mold cavity to create a pouch body (110) having an opening, and a pouch cavity (120) disposed within the opening of the pouch body (110);
wherein a shape of the pouch body (110) is the same as a shape of the mold cavity;
wherein a shape of the pouch cavity (120) is the same as a shape of the stamp (220);
d. filling the cavity with the liquid reagent;
e. placing a sealing adhesive (130) over the opening of the pouch body (110), such that the sealing adhesive (130) seals the liquid reagent within the pouch body (110);
wherein a material of the sealing adhesive (130) is liquid-impermeable, air-impermeable, and resistant to force-induced tearing;
wherein the sealing adhesive (130) is penetrated through application of the specialized device; and
f. integrating the sealed storage apparatus (100) into a microfluidic platform (300) such that penetrating the sealed storage apparatus (100) causes the liquid reagent to dispense into the microfluidic platform (300).

9. The method of claim 8, wherein the first material comprises black mylar material.

10. The method of claim 8, wherein the material of the sealing adhesive (130) comprises aluminum-coated black mylar adhesive.

11. The method of claim 8, wherein the stamp (220) comprises a thermally conductive metal stamp.

12. The method of claim 8, further comprising steps for controlling the liquid reagent contained within the sealed storage apparatus (100), the steps comprising:
a. directing the laser (230) to a point on the pouch body (110);
wherein the laser (230) causes melting at the point on the pouch body (110) such that the liquid reagent flows out of the pouch cavity (120) through the point on the pouch body (110) without mixing with the melted material of the pouch body (110).

13. The method of claim 8, wherein the microfluidic platform (300) is a centrifugal disc (CD) platform comprising one or more reagent chambers (310) and one or more collection chambers (320) fluidly connected to the one or more reagent chambers (310) by one or more microfluidic channels (330), wherein one or more sealed storage apparatuses are disposed in the one or more reagent chambers (310), wherein actuating the CD platform after penetrating the one or more sealed storage apparatuses causes the liquid reagent to travel from the one or more reagent chambers (310), through the one or more microfluidic channels (330), into the one or more collection chambers (320).

14. The method of claim 8, wherein penetrating the sealed storage apparatus (100) promotes mixing a fluid directed through the microfluidic platform (300) with the liquid reagent stored within the sealed storage apparatus (100).

15. The method of claim 8, wherein the specialized device comprises a laser (230).

16. The method of claim 15, wherein the laser (230) comprises an infrared laser.

17. A microfluidic centrifugal disk (CD) platform (300) comprising:
a. one or more reagent chambers (310);
b. one or more collection chambers (320) fluidly connected to the one or more reagent chambers (310) by one or more microfluidic channels (330); and
c. one or more sealed storage apparatuses (100) disposed within the one or more reagent chambers (310), each storage apparatus (100) comprising a sealed pouch cavity (120) that contains a fluid, wherein each storage apparatus (100) is comprised of a material that is liquid-impermeable, air-impermeable, and resistant to force-induced tearing, wherein the material is penetrated through application of a specialized device, thereby releasing the fluid.

18. A method for delivering a reagent throughout a microfluidic CD platform (300) according to claim 17, the method comprising:
a. penetrating the one or more sealed storage apparatuses (100) through use of a specialized device; and
b. actuating the microfluidic CD platform (300) such that fluid in the one or more sealed storage apparatuses (100) is directed from the one or more reagent chambers (310) to the one or more collection chambers (320).

19. The microfluidic CD platform (300) of claim 17, wherein the specialized device comprises a laser (130).

20. The microfluidic CD platform (300) of claim 19, wherein the laser (230) comprises an infrared laser.
